(19) United States
(12) Patent Application Publication
(10) Pub. No.: US 2007/0244778 A1
(43) Pub. Date: Oct. 18, 2007

(54) SYSTEM AND METHOD FOR CASH DISTRIBUTION AND MANAGEMENT

(75) Inventor: Fred Bailard, Tiburon, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MoneyNow Network, Inc., Tiburon, CA (US)

(21) Appl. No.: 11/691,409

(22) Filed: Mar. 26, 2007

Related U.S. Application Data
(60) Provisional application No. 60/786,901, filed on Mar. 28, 2006.

(51) Int. Cl. G06Q 40/00

(52) U.S. Cl. 705/35

(57) ABSTRACT

A multi-channel delivery system can be used to provide instant, 24 hour access to financial services. A customer can apply for a financial service through any of a number of channels, such as a Web, call center, or branch channel. After receiving a pre-approval, the customer can travel to a branch channel, where necessary, in order to undergo an identity verification process and receive a decision on the application. If approved, the financial service can be provided within about five minutes of approval, such as by transferring funds to a debit card. For subsequent financial service requests, the customer can access the system through one of the channels at any time of the day to receive an automated decision and, if approved, funding of the request within five minutes of approval.

### CROSS-REFERENCE TO RELATED APPLICATIONS

This application claims priority to U.S. Provisional Patent Application Ser. No. 60/786,901, filed Mar. 28, 2006, entitled “System and Method for Cash Distribution and Management,” which is hereby incorporated herein by reference.

### BACKGROUND OF THE INVENTION

People requiring various financial services, but lacking a bank account or available funds, for example, often utilize any of a number of institutions providing services such as cash advances, loans, check cashing, bill payment, and money transfers. These institutions typically include manned locations such as check cashing stores, loan stores, cash advance stores, and courtesy counters at various retail establishments. These locations provide employees trained to process these financial transactions. The need for a physical store and a trained employee increases the cost of doing business, which is passed on to the customer in the form of higher fees. Further, such a store typically is not open 24 hours a day, providing limited access for customers. Further, these stores often are located in areas where safety may be an issue, such that customers might be afraid or unwilling to visit the store. Similar problems exist with customer service counters at retail establishments.

Another option for obtaining these services includes the ability for a customer to access any of a variety of Internet sites that offer services such as cash advances or bill pay. These sites allow a customer to enter personal information, through a Web site, that is transmitted to a location where a person will review the information and determine whether the customer is approved for a cash advance or other financial service. Upon approval, the customer is notified that the financial transaction will proceed. A problem with such sites, however, is that the customer typically is only guaranteed to receive the funds within 24 hours. In the case of an emergency or other immediate need, this may be unacceptable. Further, many of these sites require either a bank account or a credit card, which a customer might not have or might be unwilling to provide over the Internet. Further still, these sites require Internet access to either enter the information or determine a number to call to provide the information over the phone.

Other recently-developed options include cash advance machines and multi-function ATMs that provide services such as the purchase of money orders and automated check cashing. These machines use customer identification devices, such as biometric readers, PIN numbers, and user ID cards, to validate a user and provide financial services. These devices typically are connected to a central location that determines whether to approve the transaction. One problem with these machines is that the approval process can be lengthy, which can be frustrating for the customer and can limit the number of transactions in any given period. Also, these machines often require credit bureau data to authenticate the customer, which can be outdated or unavailable for many customers. Further still, these machines require ATM functionality as well as other functions such as high speed data transfer, which can greatly increase the cost of each machine. This cost then is passed on to the customer.

Accordingly, there is a need for systems and methods that overcome the above and other deficiencies in existing transaction systems, in particular financial transaction processing systems.

### BRIEF SUMMARY OF THE INVENTION

Systems and methods in accordance with embodiments of the present invention use an automated decisioning process and multi-channel delivery to provide a variety of customers with 24 hour access to financial services. A customer can apply for a financial service through any of a number of communication channels, such as a Web, call center, or branch channel. After receiving a pre-approval, the customer undergoes an identity verification process and receive a decision on the application. If approved, the financial service can be provided within about an hour, within about 15 minutes, or within about five minutes of approval, depending upon the embodiment, such as by transferring funds to a customer debit card. For subsequent financial service requests, the customer simply accesses the system through one of the communication channels at any time of day to receive an automated decision and, if approved, funding of the request occurs almost immediately, such as within about five minutes of approval.

In one embodiment, a multi-channel delivery system includes a central decisioning system configured to accept application data for a requested financial service and determine whether to approve the request. The system includes multiple channels, such as a Web access channel, a telephony channel, and a branch location channel, each providing a point of access to the central decisioning system. A funds management system can be used to provide the requested financial service for an approved customer almost immediately, such as within about five minutes of the approval. This can include, for example, funding a debit card assigned to the customer by an approved amount of the requested financial service. The customer may have no pre-existing relationship with the system, and may not provide any immediate transfer of funds to the system.

In one embodiment, a process using such a system involves receiving application data for a requested financial service for a customer through any of a Web access channel, telephony channel, and branch channel. A preliminary approval determination is made for the customer using a central decisioning system, with the preliminary approval determination being provided to the customer. The system also receives authentication data for an approved customer through a branch channel. A final approval determination is made for an authenticated customer using the central decisioning system, and the final approval is provided to the customer. If the customer receives final approval, the requested financial service can be funded almost immediately, such as within about five minutes of the final approval determination.

In one embodiment, an existing customer requests a subsequent financial service through any of a Web access channel, telephony channel, and branch channel. Existing customer information is used with a predictive decisioning model to automatically determine whether to provide the requested financial service. If approved, the subsequent request can be funded almost immediately, such as within about five minutes of the approval.

Other embodiments will be obvious to one of ordinary skill in the art in light of the description and figures contained herein.

### BRIEF DESCRIPTION OF THE DRAWINGS

Various embodiments in accordance with the present invention will be described with reference to the drawings, in which:

FIG. 1 is a diagram showing components of an exemplary multi-channel delivery system in accordance with one embodiment of the present invention;

FIG. 2 illustrates a financial services architecture that can be used with a system such as that of FIG. 1 in accordance with one embodiment of the present invention;

FIG. 3 illustrates a system configuration for a Web-based approach in accordance with one embodiment of the present invention;

FIG. 4 illustrates a database sourcing structure that can be used in accordance with one embodiment of the present invention;

FIG. 5 shows the flow of requests in a three-channel system in accordance with one embodiment of the present invention;

FIG. 6 illustrates a delivery model that can be used in accordance with one embodiment of the present invention;

FIG. 7 illustrates a process flow in accordance with one embodiment of the present invention;

FIG. 8 illustrates an approval process that can be used in accordance with one embodiment of the present invention;

FIG. 9 illustrates an underwriting process that can be used in accordance with one embodiment of the present invention;

FIG. 10 illustrates a request process for (a) a pre-approved customer and (b) an existing customer that can be used in accordance with one embodiment of the present invention;

FIG. 11 illustrates a check cashing process that can be used in accordance with one embodiment of the present invention;

FIG. 12 illustrates a money transfer process that can be used in accordance with one embodiment of the present invention;

FIG. 13 illustrates a portion of a graphical user interface that can be used in accordance with one embodiment of the present invention;

FIG. 14 is a diagram of a store branch workstation that can be used in accordance with one embodiment of the present invention;

FIG. 15 is a diagram of a mall branch workstation that can be used in accordance with one embodiment of the present invention;

FIGS. 16(a) and (b) are diagrams of satellite branch workstations that can be used in accordance with one embodiment of the present invention.

### DETAILED DESCRIPTION OF THE INVENTION

Systems and methods in accordance with various embodiments of the present invention can overcome the aforementioned and other deficiencies in existing transaction systems and services, particularly those providing various financial services. One such system utilizes multi-channel delivery to provide a seamlessly and fully integrated customer acquisition and service delivery platform that is both highly scalable and highly reliable. In one aspect, the service delivery platform provides immediate, 24 hour Web-based access to a wide variety of financial services, through a variety of communication channels. In certain aspects, the communication channels include in-store branches, satellite locations, kiosks, Web sites, and call centers. Such a system provides immediate access to funds through the use of an ATM/debit card, or another appropriate card such as a smart card, memory card, or credit card, which allows for immediate electronic funding. This cashless approach makes branches safer, and allows for the use of unmanned locations, as well as call center and Internet options. These services are provided while ensuring high integrity, security, confidentiality, and efficiency measurements, while also ensuring compliance with local and federal regulations. Such a system can be much more cost efficient than existing systems, allowing for lower fees for customers (such as about $9 for a cash advance vs. about $36 for some existing systems). Such a system also provides for reduced loss exposure through enhancements to the customer validation process using technologies such as biometrics, electronic scanning source documents, data sourcing and/or validation, and capture of key information remotely.

Multi-Channel System Overview

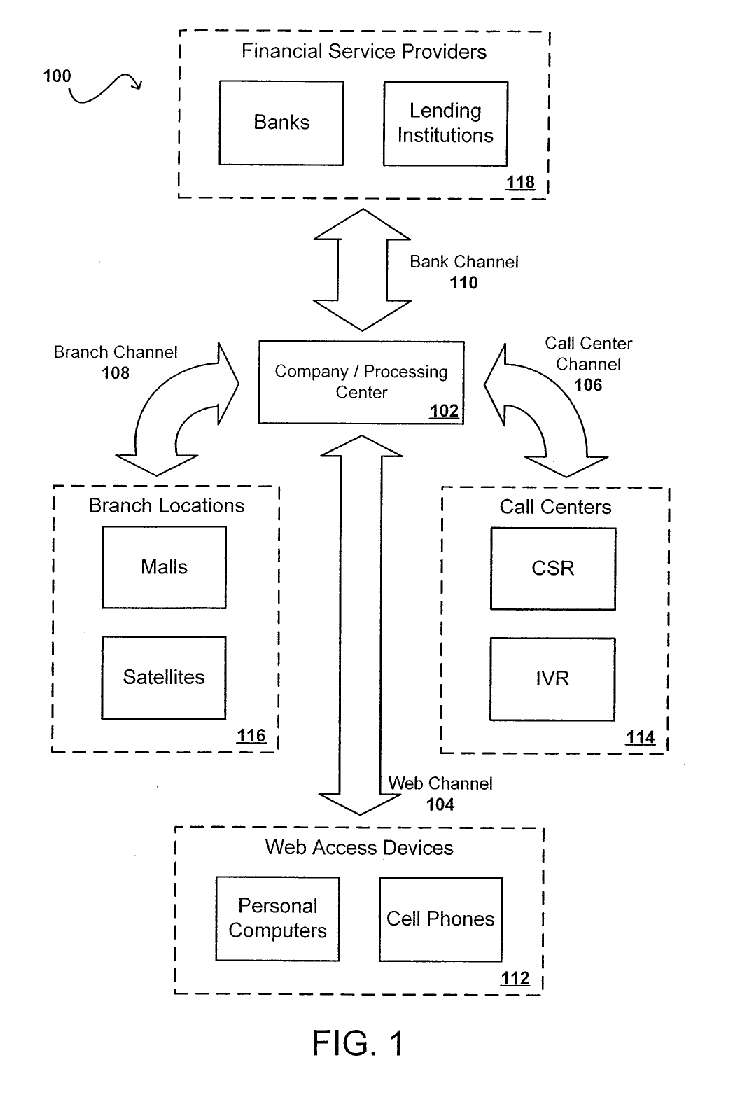

FIG. 1 shows a diagram for an exemplary financial services system 100 utilizing multi-channel delivery, providing a seamlessly integrated customer acquisition and service delivery platform. In such a system, a company or financial service provider 102, or a processing center thereof, is able to receive information from, and deliver information to, a variety of customers using a plurality of different delivery channels. These channels can include, for example, a Web channel 104 that allows a customer (with an existing relationship or with interest in a relationship) to communicate with the company through a company site using any of a number of possible Web access devices 112. It should be understood that while communication may commonly take the form of a user accessing a Web site through an Internet connection at a PC, any of a number of similar delivery methods can be used, such as accessing a content page on a cell phone, PDA, or other data processing device or terminal using a wireless connection or hard-wired connection. The Web channel can use any appropriate combination of hardware and/or software as known in the art. Web requests can be submitted via any appropriate delivery protocol or mechanism, such as through an HTTP request, via the transmission of an XML document, or via an email message. The transmission can be encrypted to ensure security and compliance with privacy regulations.

A customer also can communicate with the company 102 using a call center channel 106. A call center channel, or telephony channel, allows a user to dial in to the call center 114 using a phone connection, whereby the customer can exchange information with the company 102. In one embodiment, a customer service representative (CSR) can answer the call and interface with the customer. A call center also can gather information, communicate with the user, provide information, and/or guide the user using any appropriate technology known in the art, such as an automated menu system or interactive voice response (IVR) system. In one embodiment, the call center channel uses an IVR system to allow a caller to select an option from a voice menu, wherein a computer system presents the caller with pre-recorded voice prompts to which the user can respond orally or through pressing the appropriate number on a phone keypad. In another aspect, the system uses speech recognition software to interpret oral responses from the caller, and can use Text-To-Speech (TTS) or other technology to “read” information stored in a text document or other electronic file to the user using computer-generated synthesized speech. A call center also can use automatic call distributor (ACD) technology to route the call to the appropriate CSR or pre-recorded message. The IVR, ACD, and any other such systems also can be outsourced where appropriate.

A customer also can communicate with the company 102 using a branch channel 108. Communication using a branch channel typically will involve a customer visiting a physical branch location 116, such as an island store at a mall or shopping center, a counter or kiosk at a retail outlet, or a dedicated store location. These branch locations may include at least one trained employee, typically at mall island and store locations, available to assist the customer and answer questions. The kiosks and other standalone branch locations may not include trained employees, but may include all the technology and interactive guides necessary for a user to communicate with the company to accomplish the desired task(s). The technology and processes available through each of these branch types will be discussed in further detail later herein.

The company 102 in turn can communicate with banks and other financial institutions through a bank channel 110. This bank channel 110 may be available only to the company, or may in some instances be available to the user either through the company 102 or directly using one of the other channels 104, 106, 108. The company can use the bank channel 110 to communicate the necessary information to the financial institutions, in order to obtain a decision and/or at least a portion of the desired financial service. For instance, where a user requests an instant cash advance, the company 102 can contact a financial institution in order to have a specific cash amount transferred electronically to an account tied to a debit card given to the user by the company 102. The company 102 then relays a response to the customer through that channel which the customer used to contact the company. This response in most cases will take only a short amount of time, such as on the order of a few seconds or less than a minute, depending on the request and/or the system, such that the user can remain available through the appropriate channel until a response is received. In other embodiments where the decision might take more than a short amount of time, or where the customer will not be available to receive the response through the channel, the company 102 can instead contact the user through any other appropriate means, such as through an email message, a voice message, a text message, or a phone call.

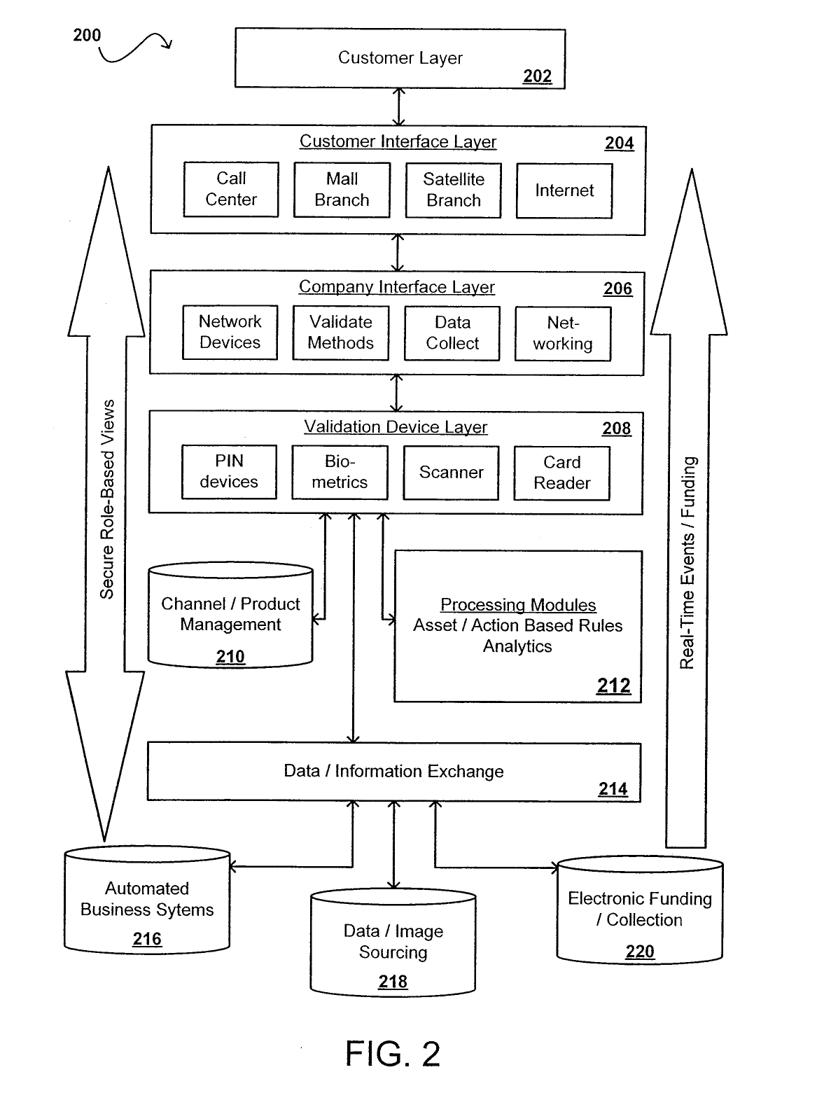

FIG. 2 shows an exemplary architecture 200 through which the system of FIG. 1 can communicate with customers to provide financial services using automated and centralized decisioning, which can be based on a predictive model and various sets of business rules. In this architecture 200, a customer layer 202, representing the various existing and potential customers, communicates with the company through a customer interface layer 204. The customer interface layer 204 can include any of the various communication channels discussed above with respect to FIG. 1, such as a call center, Internet site, or branch location. While the figure shows two exemplary branch types, namely a “mall branch” for a location in a mall or shopping center and a “satellite branch” representing a kiosk or counter in another retail establishment, for example, it should be understood that these are merely examples and the layer could include any of the branch types discussed or suggested herein. Using the customer interface layer 204, the customer exchanges information with a company interface layer 206. The company interface layer 206 can include, be in communication with, or otherwise have access to a number of devices and services, such as networking devices and/or methods, validation devices and/or methods, and data collection devices and/or methods known or used in the art. Various components of this layer will be discussed in further detail below.

The company interface layer 206 is in communication with a validation device layer 208, typically found at a branch location but potentially positioned at any other appropriate location. The validation device layer 208 can include any appropriate device (and corresponding software, etc.) and/or software useful for validating the identity of a user. For example, the layer can include at least one of a personal identification number (PIN) entry device, digital signature capture device, audio signature capture device, pen tablet, check reader, image/document scanner, card reader, camera, or biometric device (e.g., retinal scanner, fingerprint reader, or facial recognition system). These devices can be used, as discussed below, either by an employee or the customer in order to attempt to validate the identity of the customer. In one embodiment, a customer assessment engine requires only a valid ID and a personal check, along with biometric data, to validate a user.

The company interface layer 206 also has access to any of a number of appropriate “back-end” systems and devices useful for serving the requests of the customer through the customer and company interface layers. One such back-end device is a channel/product management database 210, which can include information for operating and serving the channels of the customer interface layer 204, as well as the operations of the company interface layer 206. The database can include any appropriate data storage device, method, or system known in the art, such as at least one database, data store, data repository, or data cluster. The data can be stored on a single device or can span multiple devices, either locally or remotely.

Other such back-end devices can include a number of processing modules 212 for storing and/or processing rules and analytics useful for operation of the system. These modules can include, for example, asset and/or action based rules that can be used for prioritization of tasks, assignment of tasks, tracking, reporting, measuring, event triggers, development and implementation of action schedules, as well as notifications. These modules also can include various business analytics, such as those related to the capture and verification of customer data in real-time, such as biometrics and other data, as well as warehouse sourcing, underwriting, and risk management. Descriptions and uses of these rules and analytics will be described in further detail later herein. These modules can be implemented in any combination of software and/or hardware using a computerized or processing system as known in the art.

The company interface layer 206 in this embodiment also communicates with a data and information exchange layer 214, which can contain and provide access to a variety of information necessary to serve a customer and/or company request. The data and information exchange layer 214 can provide access to any of a number of appropriate data sources, databases, or data stores, such as an automated business systems database 216, a data/image sourcing database 218, and an electronic funding/collection database 220. The information exchange layer also can provide access to risk management data sourcing and outsourcing tools, such systems and databases being associated with financial institutions, merchants, etc., which can be used to construct a customer lifecycle model useful for risk management, based on data such as orientation, retention, and collection information.

As shown by the arrows in FIG. 2, such an architecture provides for secure role-based views between the back-end data systems and the company interface layer 206 and/or customer interface layer 204. The roles can be established as known in the art, wherein a user is granted view and/or write access to a specific set of data, information, devices, or services based on the profile, type, or class of user. The secure nature of these views ensures that a user does not have access to more information than intended. This can be particularly important where information such as financial, company, credit, and personal information for a number of users and/or institutions may be contained in the same system.

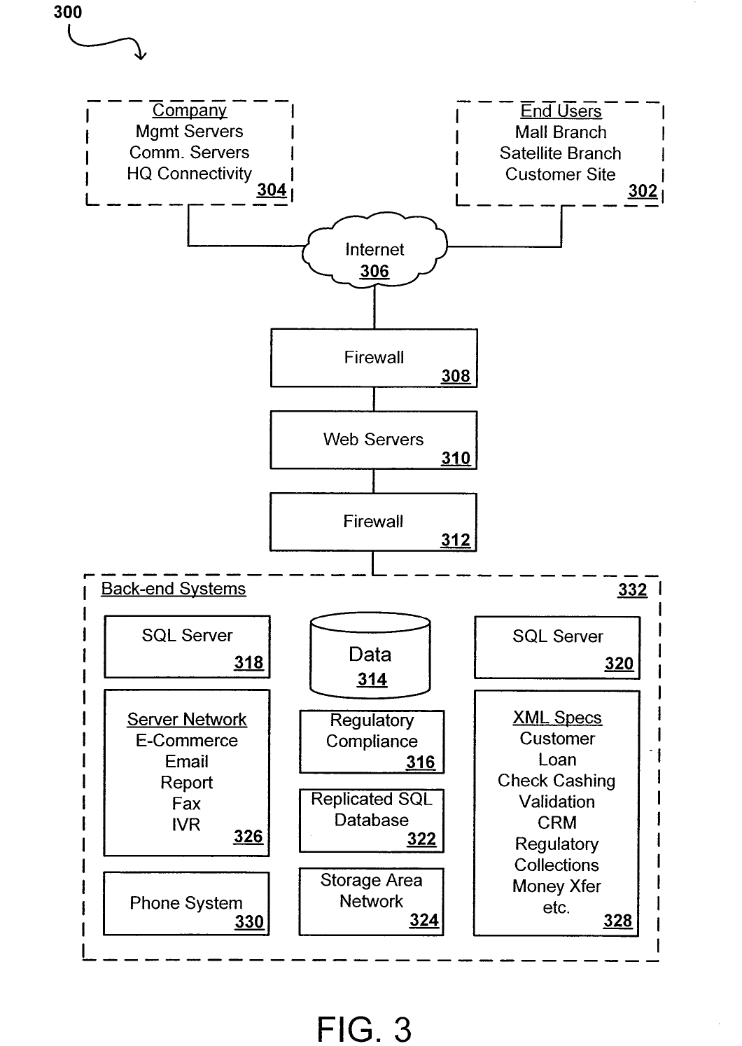

The infrastructure of the back-end systems can be designed using any appropriate technology and configuration known or used in the art. For example, FIG. 3 shows a system configuration 300 in accordance with one embodiment where customers through the various channels 302, as well as the company and associated entities 304, access the back-end systems through the Internet 306 using a Web-based approach. Since this access approach is Web-based, the back-end systems can be located behind at least a first firewall 308 in order to ensure that only authorized users are able to access the back-end systems. The firewall 308 can be any appropriate firewall known or used in the art for such systems and will not be described in detail herein. Behind the first firewall 308 is located any appropriate number of Web servers 310 useful to provide the Web-based functionality. The number, type, and configuration of these Web servers can be determined as known in the art, and as such will not be discussed in detail herein. Behind the Web servers is located at least a second firewall 312 ensuring authorized access to the data and other back-end functionality not specifically related to serving Web requests.

Behind the second firewall 312 are located various back-end data systems and servers 332. For instance, this example shows a master database 314 as well as a separate device for ensuring regulatory compliance 316, such as compliance with the Fair Debt Collection Practices Act and all pertinent federal, state, and local laws. The back-end systems also can utilize an integrated data management and analysis solution, such as SQL Server 2000 or 2005 available from Microsoft Corporation of Seattle, Wash. SQL Server 2005, for example, is a database platform that can provide enterprise-class data management with integrated business intelligence tools. Any number of process instances may be included in the back-end systems 332. As shown in FIG. 3, for example, this can include separate instances 318, 320, with a first instance 318 managing a server network 326 that can include, for example, e-commerce, email, report, fax, IVR (and associated phone system), and other appropriate business servers. A second instance 320 can be used to manage various XML transaction specifications 328, where the system is XML-based. If the system is based on another appropriate standard, then the second instance can manage and ensure compliance with that standard. There can be any of a number of XML transaction specifications 328, such as specifications for a new member request, new loan request, new check cashing request, validation/biometrics process, money transfer, underwriting/scoring transaction, card management process, customer update request, user update request, branch management request, CRM request, regulatory/compliance process, or collections request. Each SQL server instance 318, 320 also can be in communication with a storage area network 324 and a replicated database 322 ensuring proper speed, functionality, and redundancy for the system as known in the art.

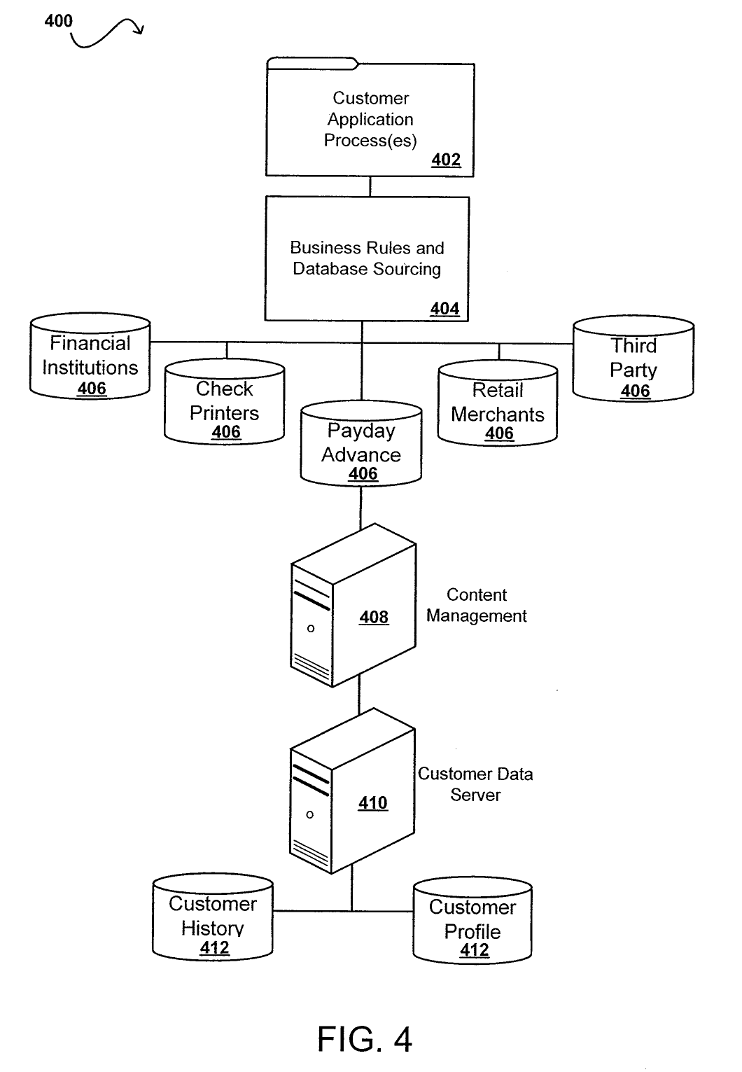

Any of a number of database sourcing structures can be used to serve customer requests and access these back-end systems, such as the exemplary sourcing structure 400 shown in FIG. 4. In this structure, a customer application process 402, which can be generated through software code on a company, customer, and/or third-party-based device such as a Web browser or company terminal, can access the databases through a set of business rules and database sourcing processes 404. These processes 404 determine whether a request for access via the customer application is accepted or declined. Rules-based access can depend upon a number of factors, such as the authentication of the user and the permissions of that user, as known in the art. If access is granted, the customer application process 402 can have access to any of a number of appropriate databases, data stores, or data repositories 406, such as may include information related to financial institutions, check printers, payday advance data, retail merchants, and third party vendors. The customer application process 402 also can have access to a content management system 408, which can be used to make decisions and process requests that may relate to matters such as customer identification and credit decisioning. For example, a credit evaluation can be done for each potential customer to develop a comprehensive and accurate risk profile. This can be based upon information such as any accounts previously closed for abuse or fraud, account-opening inquiries, deposit-account collections, check-order histories, and retail NSF check-writing histories. This information can be obtained from third party sources, such as ChexSystems, a leading new account verification and risk-management service, SCAN, a check authorization network, Deluxe Corporation check printers, and other sources. This data can be used with a credit assessment engine, for example, to determine a likelihood of repayment. For example, a person with two or more check orders over the previous three years is 22% less likely to default on a payday loan transaction, while a person with an unpaid NSF item during the previous three years is twice as likely to default on the same transaction. Taking advantage of such knowledgeable industry vendors not only improves accuracy based on proven technology, but when incorporated with predictive decision modeling and appropriate business rules results in highly consistent risk scores and decisions.

The customer application process 402 also has access to a customer database 410, which may include an associated data management system. The customer database 410 can include any of a number of different types and/or tables of data 412 relating to the customers, such as customer history information that can include data such as past cash advances, cashed checks, or other financial services previously provided to a user, as well as customer profile information, which can contain data such as product pricing, promotional offerings, and risk assessment data relating to a given customer. The customer database 410 also can include any other type of data useful for servicing client requests, such as address and identification information, as well as credit information. The “customer database,” as should be understood to one of ordinary skill in the art, does not require that a single database hold all customer data, but can include any of a number of databases, data stores, data repositories, data servers, data management systems, and other devices known or used for handling and storing data and serving data requests.

A multi-channel delivery system such as the one described with respect to FIG. 1 also can include any of a number of other components useful for providing the various financial services described and suggested herein. For example, the system can include a plurality of ATM/debit card generating devices. These can be located at third party locations, such as banks connected to the system, which are capable of generating and issuing debit cards in response to an approved customer request. In one embodiment, a bank receiving an approved request generates a debit card having an amount associated therewith that is to be issued to the customer, such as by mailing the card to the customer. In another embodiment, the debit card generating devices are located at each branch location. In this approach, the branch has a supply of “empty” debit cards, such that when a customer receives approval of a request, the device simply associates the approved amount of money with the card. The card then is transferred immediately to the customer such that the customer has immediate access to the money. In one embodiment, all card funding amounts are loaded centrally from data center operations.

Immediate funding of an ATM/debit card can be desirable, as a primary advantage to such a system for many customers can be the rapid availability of funds. Also, such an approach allows the company issuing the debit card to control use of the card through the PIN number and access of the funds. For instance, if the card is reported stolen, or if there has been any unauthorized use, the company can immediately change or delete the access PIN in order to prevent further unauthorized withdrawal of funds. Further, if the credit state of the customer changes, such as where the customer defaults on a loan to the company or otherwise drops to a lower status level, the company can cut off access to the funds so that the customer does not go further into debt with respect to the company. These features help with the management of risk, as will be discussed in further detail below.

As discussed above, the system also can include any of a number of biometric or other such devices useful for customer identification. These devices can be located at any appropriate location, such as at a branch location, where it is desired to authenticate a customer. Any appropriate biometric device can be used, such as a device for analyzing facial characteristics, analyzing fingerprints, analyzing hand geometry, scanning and analyzing the retina or iris, analyzing a signature or the voice of a customer, or analyzing the pattern of veins in the back of the hand and wrist. This information can be captured during an initial application or validation process, then stored by the system for later authentication of the customer. As will be discussed in further detail below, the biometric data can be added to an image file for the customer, which can include other information such as a digital image of the customer and other related data.

General Process Overview

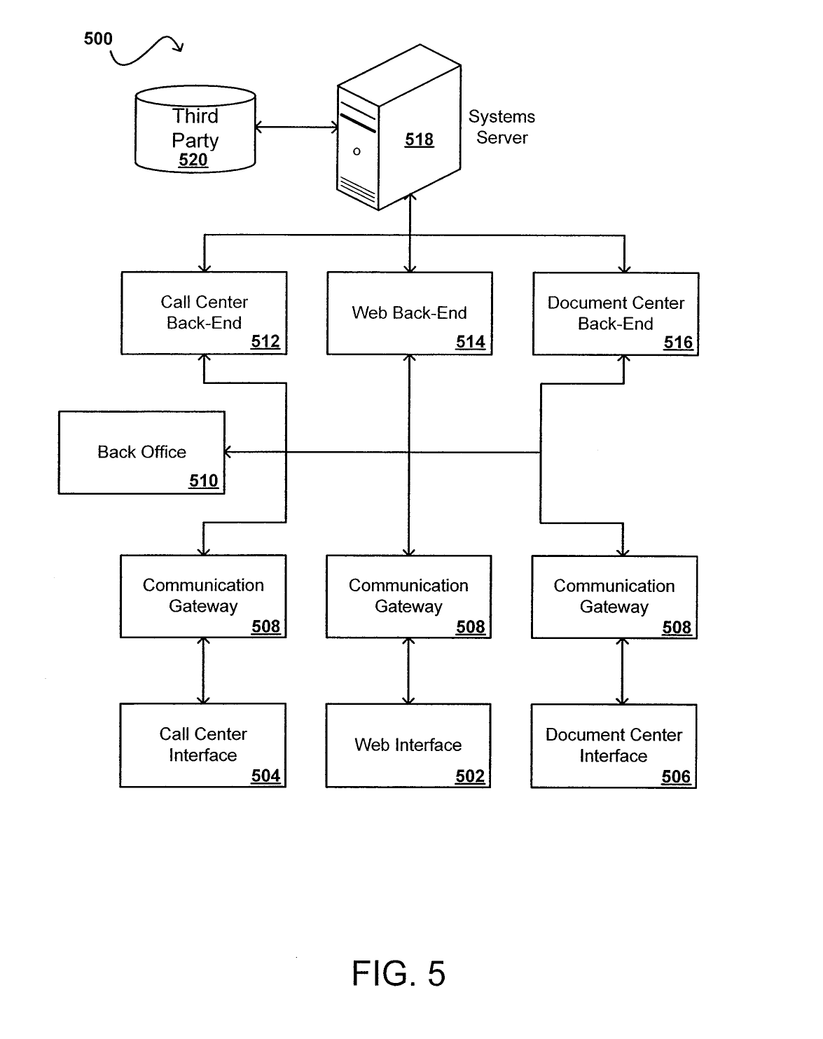

Using a multi-channel delivery system such as described above, any of a number of appropriate process flows can be used to receive and serve customer requests. One such process flow will be described with respect to the exemplary system 500 shown in the diagram of FIG. 5. In this process, an existing or potential customer can access the system through one of the customer channels. For example, the customer might access the system by accessing a Web interface 502 from a personal computer, PDA, cell phone, or other data processing device. From a Web site, the customer can obtain basic information, view a frequency asked questions (FAQ), or do any of a number of other appropriate tasks.

Once the customer decides to utilize the system for financial services, the customer can access an application page. The customer can fill in the pertinent information, then submit the application. The customer also has the option of saving a partially completed application, such as where the customer needs to obtain additional information or does not have time to finish the application, such that the customer can come back and finish the application at a later time. If necessary, the customer can submit scanned documents or can fax support documents (bank statement, utility bill, etc.) to a company location to go along with the application. Faxing can be useful for both Web and call center applications.

Once the customer completes and submits the application, such as by selecting a “submit” option on the displayed Web page, the application data is sent through a communication gateway 508 and a Web server 514 to a system server 518. The system server 518, which has access to the appropriate databases and business rules, makes a determination as to whether the application data meets pre-established criteria qualifying the customer for the requested financial service. The rules and criteria for such determination will be discussed in greater detail below.

If the systems server 518 makes a decision to pre-approve the customer or decline the customer, the decision is routed back to the customer to be displayed in a new page, window, panel, or other area on the screen of the customer. In other embodiments, this may take the form of a text, email, or voice message, for example. If the systems server is unable to make a decision, the systems server can request additional information from the user through the Web site, and/or can route the application data and any associated exception data to a company site, such as a back office site 510 that is maintained by the company and includes personnel trained to review the application data and the reason for the exception, and make a decision as to whether to request additional information, pre-approve, or decline the customer application.

If the customer receives a pre-approval, the customer is presented with electronic documentation including the various terms and information pertaining to the requested financial service(s). Upon reviewing the documentation, the customer can electronically acknowledge the disclosures and/or an advance agreement, such as by selecting an “agree” option on the Web page. After acknowledging and/or agreeing to the disclosures and/or advance agreements, the systems server runs a final pre-approval check to ensure that the pre-approved application is complete. The customer then is displayed a screen showing that the application has been pre-approved and that the customer is ready and authorized for the next step. In home computer systems, where the customer might have an identification system such as a fingerprint or retinal scanner connected to a home computer or other data processing device, the user may be allowed to complete the application process through the Web site. While the submission of data generally will be via a secure link, the submission of this identification data may need to comply with any related regulation defining a minimum security level.

For many embodiments, an authorized Web customer will be directed to a document center 506, such as a mall branch or store location. The customer may be displayed a list and/or map of locations near to the customer, based on information such as the home and/or work address of the customer stored in the customer profile. The customer also can have the ability to search for locations near any other address or location. The user can have the option of selecting a location to visit, such that the user can be displayed hours, contact information, and driving directions or other information relating to that location.

Another entry point in the process for potential customers is through a call center 504. A user can dial into the call center, such as by using an “800” number, in order to listen to information about the company and the financial services available. As discussed above, the customer also can be directed by an ACD or IVR system to an appropriate customer service representative. A customer service representative (CSR) can accept information from the customer to fill in an initial application, which then is submitted by the CSR. In another embodiment, the customer inputs the information directly by answering questions that are interpreted by the IVR system, which is used with software at the call center to fill in and submit the application. As discussed above with respect to the Web channel, the application passes through a communication gateway 508 and goes through a pre-approval determination using various call center back-end processes 512 and the systems server 518. Any exceptions can be handled by the back office 510. Once a pre-approval decision has been made, the decision is routed to the call center to be relayed to the customer, via a CSR or the call center system. If the customer receives a pre-approval, the customer can listen to the disclosures and advance agreements, discussed above, and can agree to the terms either verbally or through use of a phone keypad. The system then does a final pre-approval check to ensure that the pre-approved application is complete. The customer is informed that the application has been pre-approved, and the authorized Web customer is directed to a document center 506. The customer can listen to a list of locations near to the customer, and can have the ability to search for locations near any other address or location. The customer also can have the option of selecting a location, such that the user can receive hours, contact information, and driving directions or other information relating to that location.

If the customer instead first visits one of the document centers 506 directly, the customer simply goes through a pre-approval process using a method similar to the Web method or the call center pre-approval methods. For example, the customer may speak with a CSR at the document center, such as at a mall or satellite branch, who may assist the customer in filling out and submitting the application, similar to the call center method described above. The customer instead can submit the pre-approval application electronically, such as by using a kiosk or a terminal at a branch location, similar to the Web method described above. If the customer receives a pre-approval and agrees to the terms and conditions as described above, the customer can continue on to the verification process.

Once an authorized, pre-approved user is present at a document center, the customer goes through a verification process. For a location where a trained employee or store staff member is present, the employee can log in to a company site (typically Web-based as discussed above), through which the employee can bring up the customer information, such as by using an identifier or personal information taken from a printed application or pre-approval page presented by the customer. Approaches for tracking and identifying customer records contained in a data management system are well known in the art and will not be discussed herein in detail. Once the employee has access to the data, the employee enters into the system pieces of information used to identify the customer. In one embodiment, this requires entering two pieces of information, such as a scan of a driver's license and the capture of a thumb print. Other types of information can be used as well, as would be known in the art, such as a scan of a passport or green card, and the results of a retinal scan or other biometric data capture. In the event of the implementation of government-issued identification cards or chips, the system can simply scan or otherwise access such a device. A digital image also can be captured showing the customer. Once this information has been entered into and accepted by the system, an image file can be generated for the customer as will be discussed later herein and the filing of the financial service request can commence. Validation of the identification data can be done automatically or using a trained employee, through the document center back-end processes 516, the systems server 518, or the back office 510. In one embodiment, the back office contains systems and rules for validating the support documents and authorizing the funding or filling of the financial service, any step of which can be set to require human intervention and/or approval. The systems server 518 also can access third party data 520 and processes, where necessary, as described elsewhere herein.

For a location without an employee present, such as at a standalone kiosk, the customer can log in to a system-based Web site, such as by using a keyboard, mouse, and display device present at the kiosk. The login information can include an identifier given through the pre-approval process and/or any other personal identification information. Once logged in, the customer can verify or approve any previously-provided information. The customer also provides any necessary identification verification information, such as the two forms discussed above. In one embodiment, the customer slides a driver's license, passport, credit card, or other identifier into a card machine or document reader. The customer also provides biometric data, such as by using a thumbprint reader or retinal scanner at the location to capture the necessary data. The kiosk or other device also can include a camera for capturing a digital image of the customer. Instructions for using the various features of the device can be displayed to the customer through the display device, on or around the device, and/or through an audio speaker system. Once the information has been entered into and accepted by the system, an image file can be generated for the customer, as will be discussed later herein, and the filling of the financial service request can commence.

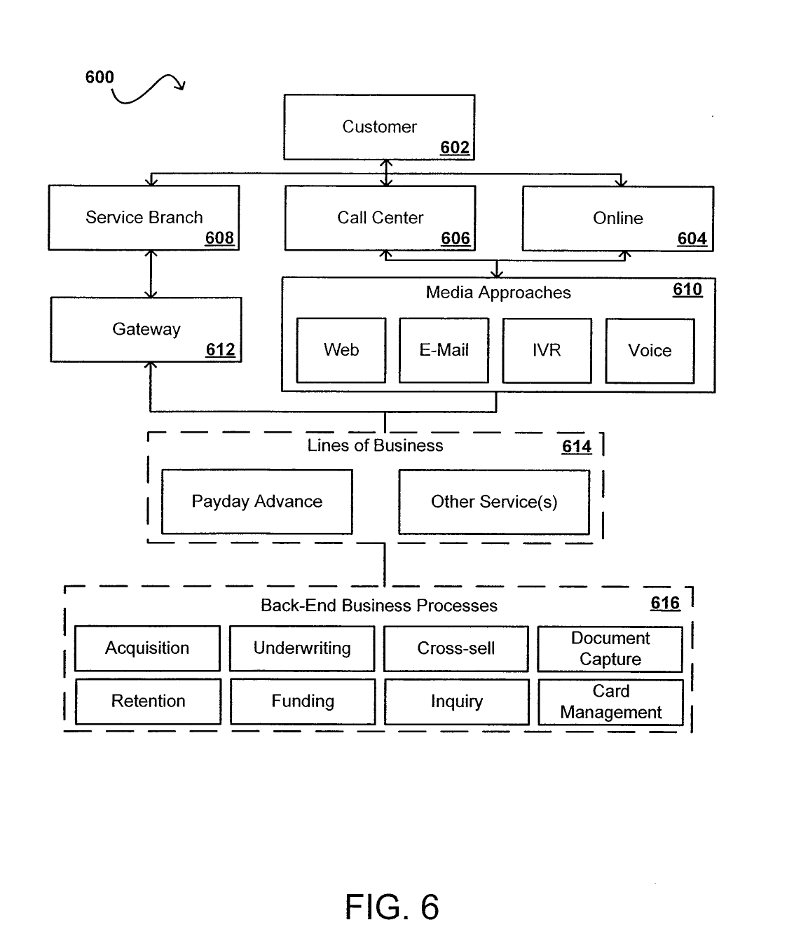

An exemplary delivery model 600 for a process such as the process described above with respect to FIG. 5 will be described with respect to the diagram of FIG. 6. In this model, the customer 602 accesses the system through one of the aforementioned channels, such as the “online” or Web channel 604, the call center channel 606, or the branch channel 608. When going through the online or call center channels, the customer can communicate with the system via media approaches 610 such as Web, email, phone and/or IVR, and voice and/or operator approaches as known in the art. At the branches, the customer can simply go through the relevant company gateway 612. The customer then can be connected to servers, devices, and/or relevant information for the selected financial service or line of business 614, such as a payday advance or other financial service. For the appropriate line of business, the system can utilize any of the appropriate back-end business processes 616, such as acquisition, underwriting, cross-sell/linking, document capture, retention, payment/funding, inquiry, and/or card management processes.

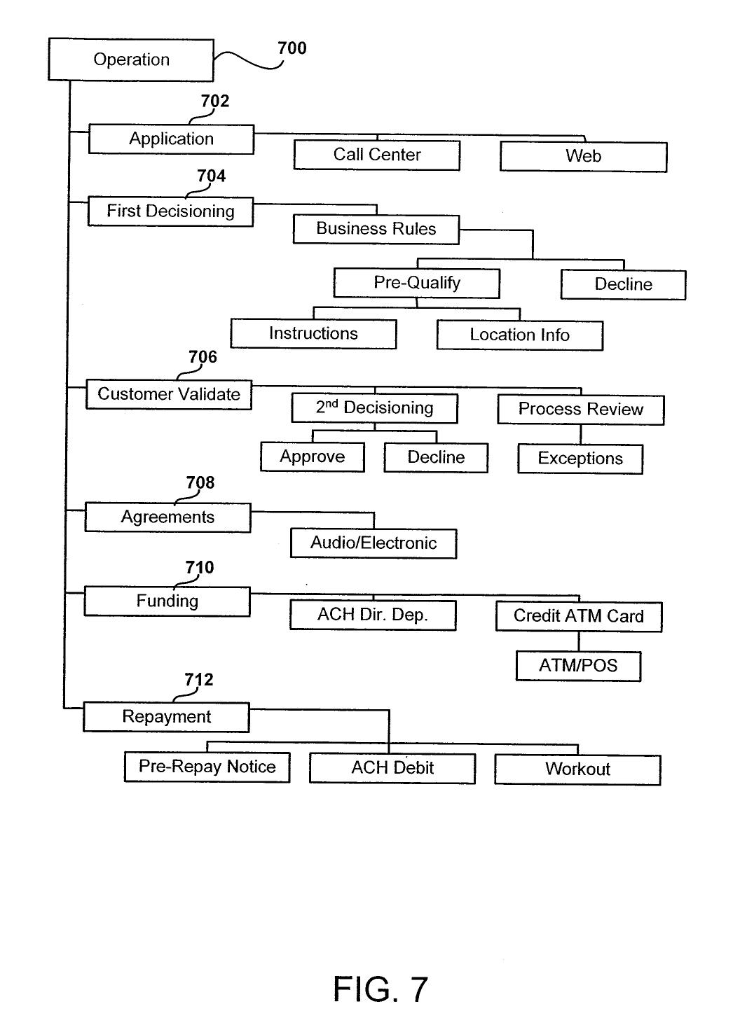

A flow chart showing flow of various business processes in an exemplary operation 700 using such a multi-channel system is shown in FIG. 7. In this process 700, the customer fills out the application in the application step 702, such as through a call center or Web application as described above. The application data then goes through a first decisioning step 704, wherein the data is used to pre-qualify or decline the customer, as well as to provide further instructions and verification location information. After venturing to a verification location, the customer goes through a customer validation step 706, wherein the customer goes through a second decisioning process after the inputting of identification verification information, and is either finally approved or declined. The process also can be reviewed by the back office in this step, specifically in the case of exceptions as discussed above. If the customer is finally approved and authorized, the authorized customer goes through an agreement step 708, wherein the customer agrees to various terms and conditions through audio and/or visual devices. Once the customer agrees to the terms and conditions, the customer goes through a funding stage 710. As will be described in greater detail below, the customer can receive the requested funding or financial services in this step, such as the crediting of a debit card for immediate cash access. After the customer receives funding, the customer can go to the repayment step 712. This step can be entered into at any time after funding, but typically will be initiated by the company system (where repayment is outstanding) after a period of time agreed to by the customer in the terms and conditions. After a period of time, the customer may receive a prepayment notice notifying the customer that repayment will be coming due. At repayment time, the outstanding debt can be credited to the company, such as by transfer from a checking account. If for some reason repayment is not made per the approved schedule, the system enters a workout and/or collections phase as will be described in greater detail below.

Approval Process

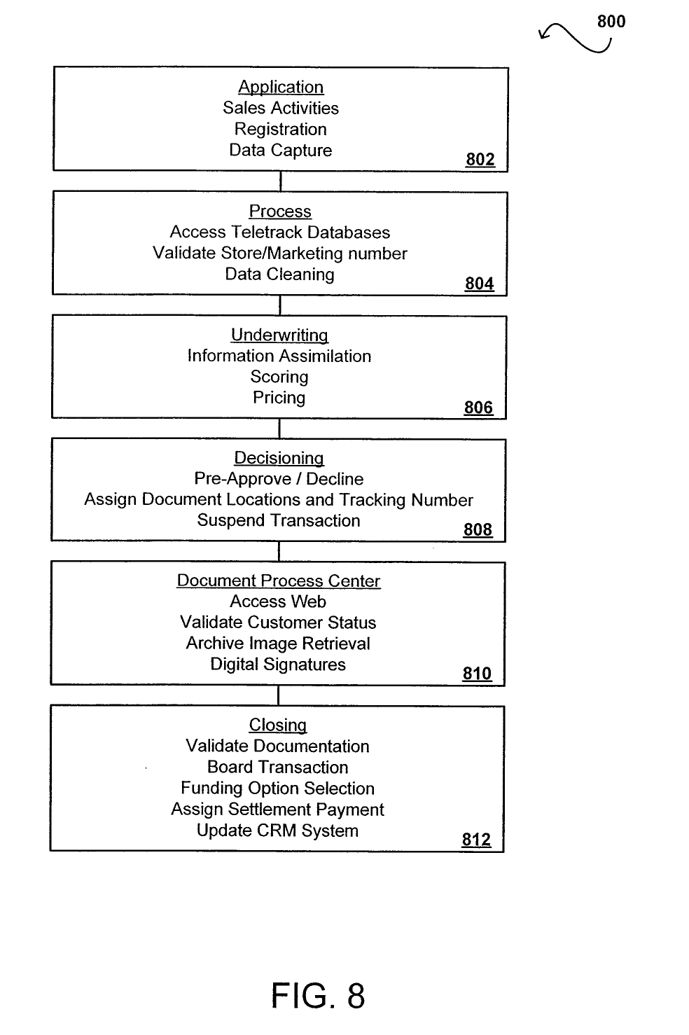

While any of a number of processes can be used with the systems and methods described and suggested above to approve a financial request for a customer, an exemplary approval process 800 in accordance with one embodiment will be described with respect to FIG. 8. A customer in this process first goes through an application step 802 as described above, which can involve various sales and marketing activities, as well as the registration of the customer and capture of customer data. The customer then goes through a processing step 804, wherein a processing system can access one or more databases such as Teletrack™ databases, available from Teletrack, Inc., of Norcross, Ga., which provide sub-prime customer credit information useful in making timely and accurate risk decisions. The system can validate a store and/or marketing number associated with the customer data to be used in crediting the proper location taking the application. Appropriate data cleaning steps also can be taken.

The customer data is then passed to an underwriting step 806, such as is described in greater detail elsewhere herein, wherein the customer information is assimilated with existing information in order to generate a risk score or other appropriate approval threshold for the customer. The risk score may have to reach a minimum value before a customer is approved for financial services, and the minimum value can vary by service. The risk score also can be used to set pricing for those financial services supplied to that customer. A higher (or lower, depending on the approach) risk score can result in higher (or lower) pricing, as a customer determined to have a greater risk of repayment may have to pay higher fees under the terms of the agreement.

After the underwriting step 806, the customer data goes through a decision step 808, wherein a decision is made as to whether to pre-approve or decline the customer application.

Processes for making such a decision are described in detail elsewhere herein. Once a decision is made, document locations are assigned for the customer data and an account tracking number is assigned to an approved customer account. At this point, an approved customer may be required to go to a document center (if not already at one) to complete the application process, whereby the transaction is suspended, to be resumed at the document center.

A pre-approved customer present at a document center undergoes a document process center step 810, wherein the customer or a trained employee accesses the Web or other system network, such as by using the account tracking number and any other appropriate information, whereby the customer status can be validated. Upon validation, images can be captured in order to verify the identity of the customer. These images can include captures of a pay stub, bank statement, utility or phone bill, driver's license, check OCR line, retinal scan, thumb print, and/or any other appropriate image helpful in determining the identity of the customer. As described above, only two of these may be needed, such as the driver's license and thumb print. The customer in one embodiment also supplies at least one digital signature, which can be used for an advance agreement, application, ACH authorization, disclosure agreement(s), and/or any other appropriate reason. Uses of digital signatures may be subject to various rules and regulations, such that the system, in one aspect, includes a process for ensuring compliance.

After document processing, the customer goes through a closing step 812, wherein a validation of all documentation is done before the board transaction is initiated. The funding option then is determined, such as funding to a debit card, direct deposit (ACH), or via wire, and the necessary funding procedures initiated. The system also assigns a settlement payment for this transaction, where applicable, such as by directing the user to settle payment at a document center, store, or with a marketing representative, and determining any relevant information, such as dates, locations, installments, amounts, fees, and penalties. After all the necessary information has been obtained and/or determined, the system updates the data in a Customer Relationship Management (CRM) or other data management system as is known in the art. In one embodiment this entire process 800 is designed to take six minutes or less (not including travel time of the customer between an offsite location and a document center, where applicable). The steps of the process from the application step 802 through the decision step 808 in this embodiment typically will take between one and three minutes, with the remaining steps taking between two and three minutes. The remaining steps, which may be required to occur through a document center in some embodiments, can occur on the same day as steps 802 through 808, or can occur up to three or more days later in this embodiment. Other embodiments may allow a transaction to be suspended for any appropriate period of time, after which the customer may be required to submit a new application. At least some customer data may be retained so that the customer does not have to completely start over for a subsequent application.

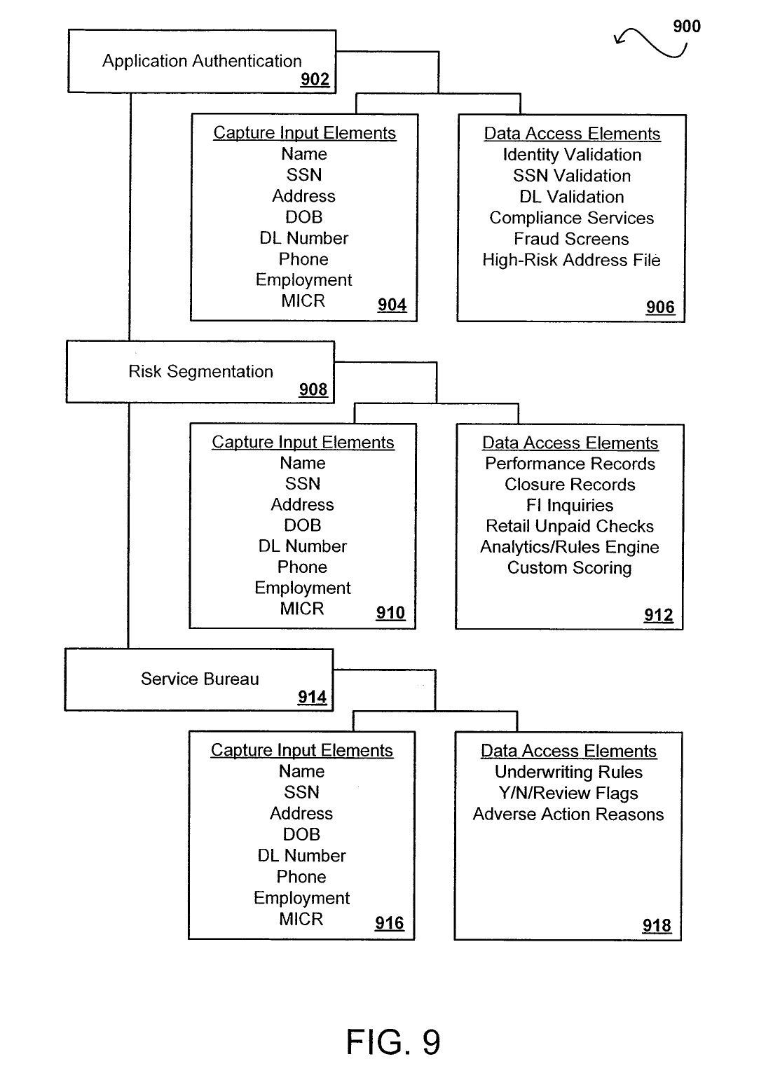

FIG. 9 includes a flowchart showing more detail of an exemplary underwriting process 900 that can be used with the process 800 of FIG. 8. In this exemplary underwriting process, the customer data goes through an application authentication sub-process 902, wherein specific customer information 904 is captured or received. Customer information 904 might include, for example, the name, social security number (SSN), address, date of birth (DOB), drivers license (DL) number, phone number, employment information, and Magnetic Ink Character Recognition MICR data (such as may be found at the bottom of a personal check). Data access elements 906 can use this data to accomplish a number of tasks, such as identity validation (using a custom match selection), SSN and DL validation, compliance services, pre-selected fraud screens, and high-risk address file tasks. These tasks can be accomplished by accessing third party data systems, specifically for tasks such as validating SSN and DL numbers as known in the art.

After the application authentication sub-processes have executed or have been performed, the customer data undergoes risk segmentation processing 908. In this process, another capture of customer data 910 occurs, which can simply involve requesting the data used in the application authentication sub-process 902. Data access elements 912 can use this data to accomplish another set of tasks, such as the analysis of performance records and closure records, FI inquiries, and contacting retail databases to locate any instances or unpaid checks and/or returned merchandise. An analytics/rules engine can be used to process the customer data and generate a custom score. An algorithm and/or set of rules can be used to generate a risk score for the customer, based on the information obtained through the risk segmentation step.

Once a custom score is generated for the customer, the customer data and custom score is passed to a service bureau sub-process 914. In this sub-process, the customer information 916 is again passed to, or acquired by, a sub-process similar to the capture process in the application authentication or risk segmentation sub-processes. After obtaining the data, data access elements 918 apply a set of underwriting rules to the data, with tags such as Yes, No, or Review (Y/N/Review) tags being associated with the data. If a “No” or “Review” flag is set, the sub-process also can generate reasons for the adverse decision to be presented to the customer. The decision and any associated reasons then are forwarded to the customer and/or a CSR working with the customer. The information also is placed into a company or other database for general recordkeeping.

Exemplary Financial Services

Once a customer is entered into the system and approved, that customer has the ability to request any of a number of available financial services. Financial and other services available through such a system can include, for example: instant cash advances, cashless check cashing, money transfers, credit card applications, bill pay, product/service purchase, mortgage loans, discount programs, identity of theft services, internet access, shopping and purchasing ability at third party stores or businesses, financial service referrals and discounts, check deposit, electronic check book, online credit management, and other such services. Such a system also can be set up with small businesses, which can demonstrate a pattern of accounts receivable, which can allow those businesses to pay invoices and obtain other financial services based on the expected incoming funds.

For example, a customer needing immediate access to cash can request an instant cash advance. For example, a payday advance typically is a small, short-term, single-payment customer loan. In an exemplary payday advance transaction, a customer writes a personal check for the sum of the loan amount, or the amount financed, as well as the finance charge. The company providing the advance agrees in writing to defer presentment of the check until the customer's next payday, which typically is 10 to 30 days later. At the next payday, the customer redeems the check by paying the loan amount and the finance charge, or the payday advance company can cash the check. In some states, the customer is able to extend the payday advance by paying only the finance charge and writing a new check. Payday advances typically range from $100 to $500, although some states permit larger payday advances.

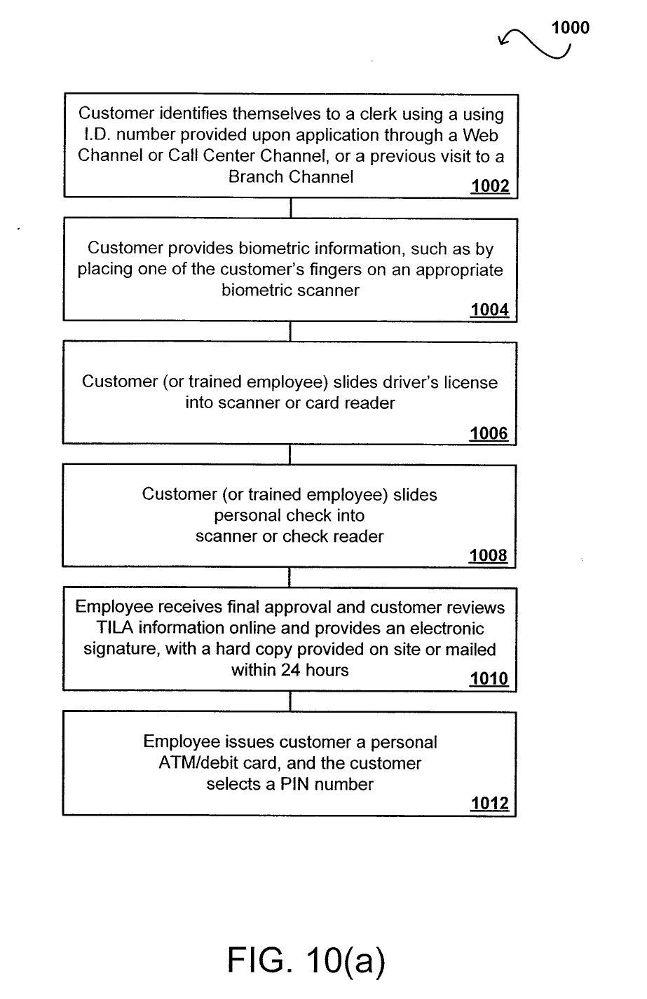

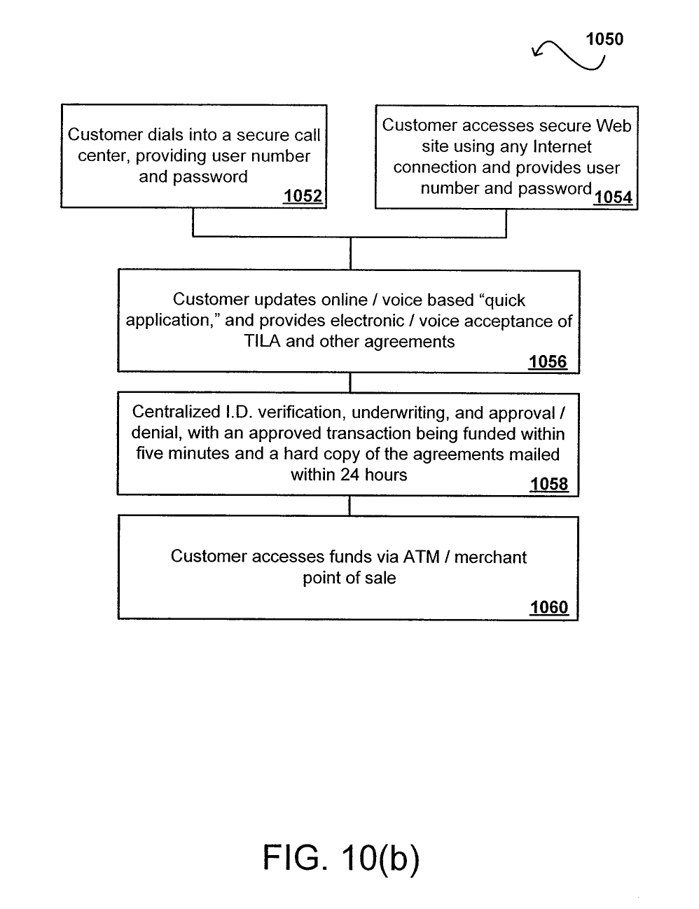

FIG. 10 shows processes for requesting an instant cash advance for (a) a pre-approved but new customer and for (b) an existing customer in accordance with one embodiment. In the exemplary process 1000 of FIG. 10(a), a customer who has already been pre-approved as discussed above provides identification information, such as a unique identification number supplied during the application process through a Web or call center channel, to an employee at a store or branch location 1002. Once the employee pulls up the information for that customer, the customer is directed to provide biometric data, such as by placing a finger on a fingerprint scanner 1004. The customer also is asked to scan, or the employee can scan, the customer's drivers license using an image scanner or card reader 1006. The customer also provides a check, corresponding to an account where the customer's paycheck will eventually be deposited, which is scanned into the system using an image scanner or check reader 1008. After the employee verifies receipt of the information, the employee submits the information to the system for final approval. Upon receiving final approval, the customer is asked to review Truth in Lending Act (TILA) disclosures and any other required information, and can provide an electronic signature using a digital signature capture device 1010. A hard copy of the TILA documentation, and any other associated paperwork, is presented to the customer, such as by on-site printing or by mailing within 24 hours. Upon capture and verification of the digital signature, the employee is authorized to present the user with an ATM/debit card tied to the customer's new account with the company 1012. The customer is asked to select a four digit PIN number, for example, such as by entering the pin number into a keypad. After the PIN number has been approved by the system, the ATM/debit card is activated so that the customer has “instant” access to the funds of the cash advance using any location where ATM/debit cards can be used. The entire process in this embodiment can take less than three minutes from the time the customer is first identified to the employee.

One of the more advantageous features for many customers will be described with respect to the exemplary process 1050 of FIG. 10(b). This process 1050 describes how an existing customer, who has already gone through a process such as is described with respect to FIG. 10(a) and has received a company debit card, can request an instant cash advance 24 hours a day from any place having Internet or phone access. In this embodiment, an existing customer accesses the system by contacting the call center via telephone, cell phone, VOIP, or any appropriate audio communication technology 1052. The customer provides a user number, username, or other identifier, as well as a password, for example, either by entering the information via a keypad of the telephony device or by speaking the information to a CSR or an IVR system. If the customer instead wishes to access the system via a data connection, the customer can access a system Web page using a computer, cell phone, PDA, or other appropriate data processing device, using an appropriate communication protocol as known in the art, and can enter the user number and password using the keyboard, keypad, touch screen, mouse, or other data entry device 1054. For a device with both voice and data capabilities, the customer can have the option of using audio and/or electronic communication.

After the existing customer gains access to the system, the customer goes through a “quick” application, or an application that builds on a previous application(s) and does not require all the processes of the prior application, by entering information (through voice or electronic data) such as the new requested amount, date of expected paycheck, or other appropriate information 1056. The customer also can verify the information that is already in the system, and have the option of changing or updating this information. After the customer verifies that the information is accurate, the customer is presented with a new set of TILA and any other documentation, which can be displayed or “read” to the user depending upon the access channel. The customer can provide acceptance to the agreements via voice or electronic approval.

After the customer approves the terms and agreements, the customer and request data are transmitted to a centralized location for identity verification, underwriting, and approval or denial of the new application 1058, using processes and devices described or suggested elsewhere herein. If the transaction is approved, the customer's ATM/debit card can be funded with the requested amount almost immediately, such as within 5 minutes of approval. A copy of the agreement(s) are provided to the customer, such as by mailing within 24 hours, fax, email, Web page display for printing, or any other appropriate communication mechanism. After the card has been funded, the customer can access the funds using any location or device that accepts ATM/debit cards 1060.

There can be many other ways for existing customers to request cash advances. In one embodiment, a customer can contact the system via the call center or an Internet connection to request an additional cash advance, without the need for an additional application process. In such an embodiment, the customer has an account that is similar to a line of credit, wherein the customer is approved for cash advances up to a given amount, such as $500, such that the customer at any time can request additional funds up to an amount that would place the customer at the maximum borrow amount. In an alternative embodiment, the customer can only request additional funds if the balance of the debit account is at $0, or at least below a certain threshold amount.

For customers with regular medical or other expenses that require relatively large payments at specific points in time, the customer can agree to have a specific amount added to the debit account from each paycheck, such that when a large amount of cash is needed the customer can have the ability to draw upon the cash in the account as well as an advance up to an agreed upon amount. For a customer who has a regular bill due date that always falls before a payday, the customer can setup a revolving cash advance that always credits the ATM/debit card with a specific amount on a specific day of the month, for example, such that the customer is always able to pay the bill. If the user does not use the amount on the card to pay the bill on any given month, the money can be directed into a checking account of the user, can remain on the debit card for use on other expenses, or can cause there to be no further funding to the card as long as the desired amount is available.

In another embodiment, the funds can be set up to pay the bill directly. If the bill comes due before a payday, the customer can agree to a cash advance that is not funded to the customer but instead is used to pay the bill via electronic transfer. A customer also can have the option of paying the bills without use of a cash advance, but simply via direct transfer from a checking or other bank account. For example, a customer might not have bill pay available with their account, or may not have Internet access to monitor the payments, such that the customer might like the ability to pay bills electronically using the system, as well as the ability to monitor the transaction history using any of the available kiosks, branches, or other channels. The application process to set up bill pay for an existing customer can be similar to any existing processes for setting up bill pay, and will not be discussed herein in detail.

In accordance with another embodiment, an existing customer can go to a standalone kiosk (or workstation), such as is described elsewhere herein. This kiosk can be located in places such as a store, mall, food court, restaurant, or any other appropriate location where a customer might need or want access to funds. A kiosk in this embodiment allows a customer instant access to funds simply by logging into the system at the kiosk and requesting the funds. For example, a customer can access the system by entering a user name or number and password into the kiosk using a keyboard or mouse, for example, and then verifying the information on a display screen. In another embodiment, part of the identification process includes the customer sliding the ATM/debit card into a card reader. After the customer enters the requested amount and verifies the information, the customer is displayed the new TILA and any other agreements (where applicable), and can approve the terms and agreement. The information then is transmitted to a central location for verification and decisioning, and if approved the customer is displayed an approval screen and the funds are quickly funded to the ATM/debit card. The customer then can have an option of printing copies of the agreements, or receiving copies by other mechanisms, such as by email, fax, or postal mail. This entire request and funding process will generally about five minutes or less. This can be desirable for customers such as mall employees who might only have thirty minutes for a lunch break but do not have sufficient cash, as the employee can simply visit the kiosk, request the amount, receive the funds, and still have enough time to eat lunch. Such ability also can be desirable for people who have unexpected expenses, or who tend to not have much extra income but need to make a purchase or pay a bill, as the customer at any time can instantly access funds even if the customer does not have phone and/or Internet access. Even though fees typically will be associated with the cash advance, the use of a kiosk does not require any immediate out-of-pocket expenditure, such that the customer can access funds without having to have any cash available to make a phone call or purchase Internet access.

Another service that can be provided to a customer through such a system is a cashless check cashing service, which provides immediate access to the funds from the check. Such a service converts a non-bank check to available cash funds, with no holds placed on funds, affordable fees, and little to no hassle-free. The service can provide for a transfer of all or part of the funds from a cashed check directly into a bank account using an Electronic Funds Transfer service, saving the customer the trouble of having to carry cash. Checks cashed can include, for example, payroll, personal, government, and travelers checks.

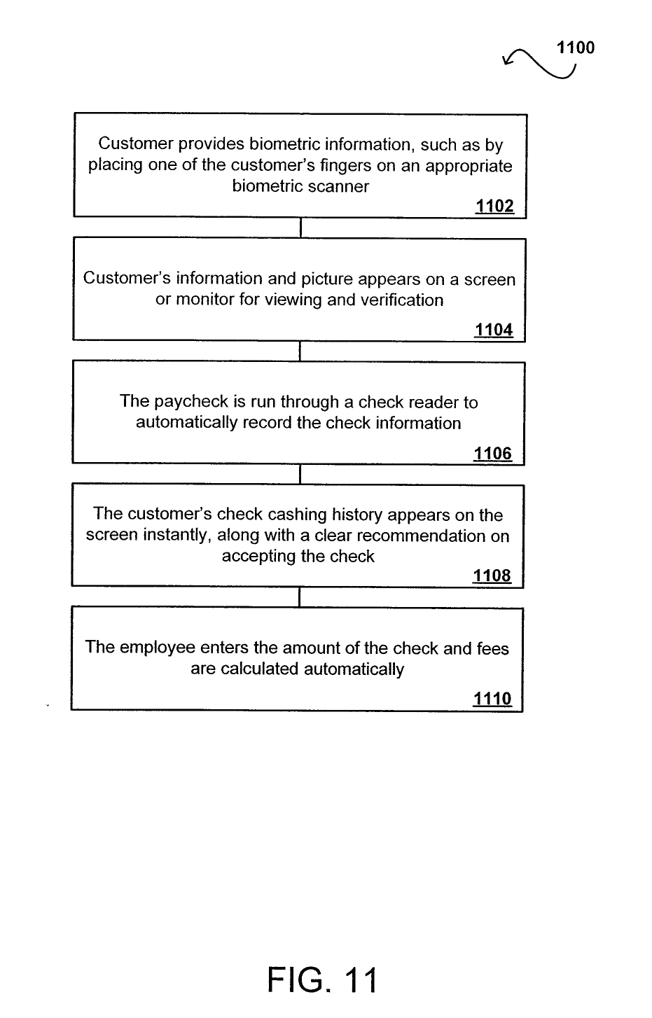

An exemplary cash checking process 1100 will be described with respect to FIG. 11. For cashless check cashing, the customer can be required to venture to a document center (such as a mall branch or company store) with a trained employee in order to verify the authenticity of the check as known in the art. In other embodiments, a kiosk or standalone store can include hardware and/or software for receiving and verifying the authenticity of the check. The process for becoming an authorized customer can be the same as described elsewhere herein. Once the customer is authorized, the customer visits a document center and provides biometric or other appropriate information for identification, such as by placing a finger on a fingerprint scanner or positioning an eye in an appropriate location for a retinal scanner 1102. (Using biometric data for identification, instead of providing a user number and password, can be used for other processes as well, and is not limited to check cashing). If the scan is successful, the customer information is displayed on a screen of an employee 1104. This screen can include an archive image as discussed elsewhere herein, or can at least include an image of the customer for help in verifying the identity of the customer. Once the customer identity is verified, the check is run through a check reader to automatically record the check information 1106. A check cashing history, a status code, a risk score, and/or any other appropriate information can be displayed to the employee, as well as a clear recommendation on accepting the check 1108. In some embodiments, the employee is bound to follow the decision of the system. In other embodiments, the employee has certain latitude in deciding whether or not to accept the check. Reasons for accepting or declining a check must follow local rules and regulations, such that for liability purposes the company may prefer to have the system make the ultimate decision as the loss due to system error may be less in the long run that the liability of various employees erroneously providing or denying acceptance. Once the check is determined to be acceptable, the employee enters or verifies the amount of the check 1110. Upon entering the amount of the check, the amount of fees associated with cashing the check are determined, whereby the customer can choose to agree to the fees and cash the check, or can reject the fees and have the check returned. If the customer agrees to the fees, the amount of the check (minus the fees) is credited to the ATM/debit card. The customer then can have access to the funds within about five minutes of initiating the transaction.

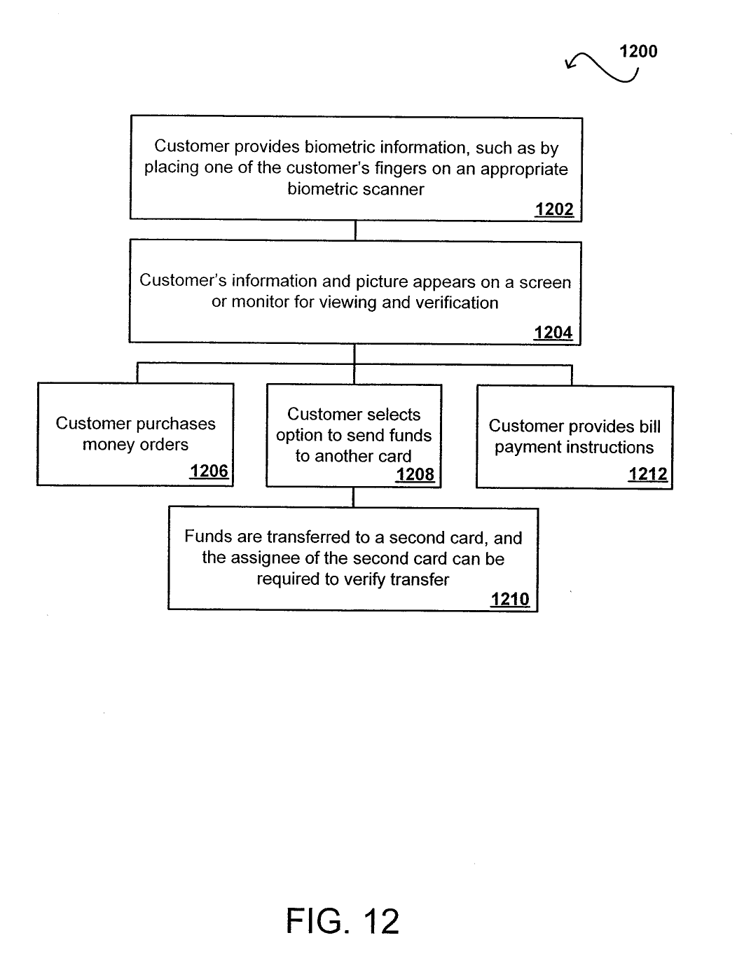

Authorized customers also can have access to money transfer services using a process 1200 such as is shown in FIG. 12. For money transfer, the customer can be required to venture to a document center (such as a mall branch or company store) having a trained employee on-site. In other embodiments, the customer can visit a kiosk or standalone store, or can access the system via phone or the Internet, for various money transfer operations (other than money order and other similar purchases). Processes for becoming a verified customer can be the same as described elsewhere herein. An authorized customer visiting a branch location in this exemplary process provides biometric data, such as a finger print scan using an appropriate scanner, in order to authenticate the user and pull up the necessary information 1202. After authentication, the information for the customer is displayed to the employee and/or the customer, such as by displaying an archive image or an image of the customer along with personal and/or historical data 1204. After the customer is authenticated, the customer is presented with a number of money transfer options. For example, in one embodiment the customer has the ability to purchase money orders through the system 1206, transfer funds between cards 1208, and provide bill payment instructions 1212.

For the money order purchase option 1206, the customer can select the amount, as well as recipient information, which can be transmitted to a central location for approval. When the customer visits a branch location or kiosk, the customer can be presented with a physical money order as a result of an approved transaction. Alternatively, the customer can have the money order automatically mailed to the customer or the recipient from another location, particularly for standalone kiosks or other channels that might not have money order printing devices available.

A customer also can select to direct funds to another ATM/debit card by selecting a card balance transfer option 1208. For this option, the customer can input an amount and identify a second card to receive the funds 1210, such as by entering a card number and/or the identity of the second card owner. The customer may also request that a second card be credited and funded so that, for example, the customer may themselves provide the funded card (e.g., via mail) to a second user. A customer might wish to transfer money to a second card for a number of reasons, such as having a child away at college in need of money or a relative that does not have access to the system but is in need of funds. In some embodiments, the customer might be required to first set up a relationship with the second card, in an attempt to prevent unauthorized transfers. If the card receiving the funds has a lower maximum amount, then the system might only allow transfer of an amount up to the maximum amount of the second card. Repayment of the amount may also be the responsibility of both cardholders. In such a situation, the second cardholder might have to connect with the system (via phone or Web, for example) to approve the transfer and accept the liability. The liability can be limited by local rules and regulations.

Another option available to an authenticated customer is bill payment 1212. A customer can provide an amount and identification information for the desired recipient, which is sent to a central location for verification and approval. Upon approval, and the customer agreeing to the various terms and conditions, the funds are electronically transferred to the desired recipient in order to pay the bill. A separate bill pay transaction can be done for each individual bill, or a customer can set up bill pay to automatically pay each bill from a particular recipient as that bill comes due, by either deducting the amount from a checking account (if available), or by using an advance against a future paycheck. A customer also can specify to only use funds from a checking account or from a cash advance, for example. The customer also can set up multiple bill pay recipients, and can specify a different payment method for each. There can be limits set on the type of recipient. For example, a customer might not be allowed to make a money transfer based on a cash advance to a credit card company or lending institution.

Storage, Arrangement, and Retrieval of Customer Data

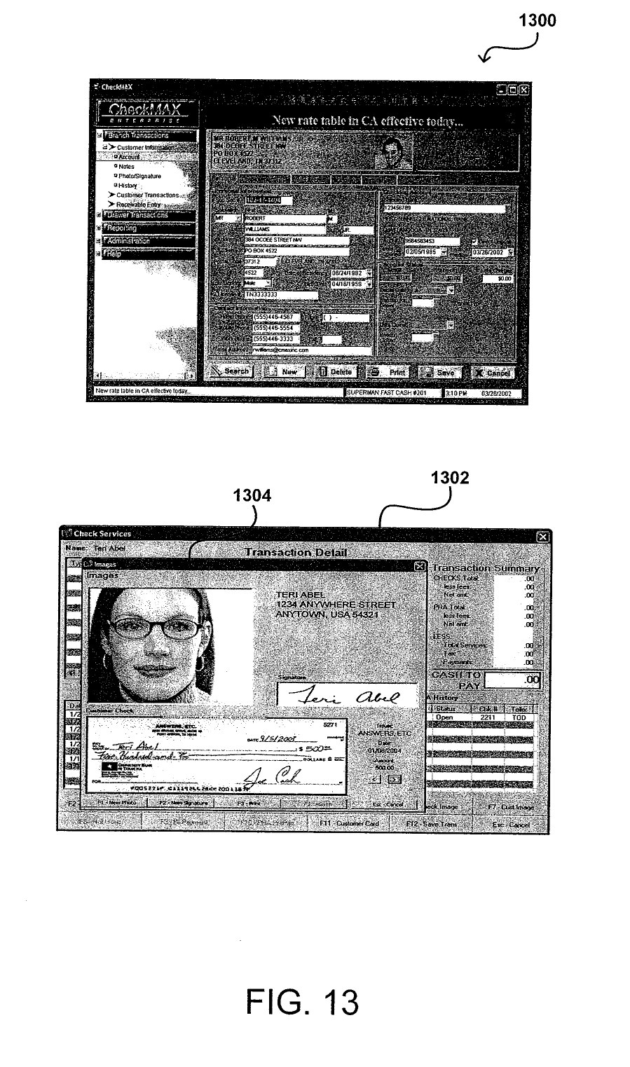

There can be a number of different interfaces used to input, display, verify, delete, and update information for a customer. For example, a customer might be presented with a first interface through a Web channel that is different than an interface the customer might see at a kiosk, with still other interfaces being available to an employee at a call center or branch location. One such interface 1300 is shown in FIG. 13. This exemplary interface can be used by a CSR at a branch location, although many features and appearances may overlap with interfaces presented to other users or at other locations. As can be seen in the figure, this interface 1300 breaks down information access into five major categories, including access icons for branch transactions, drawer transactions, reporting, administration, and help categories. Interfacing with information categories such as reporting, administration, help, and other categories are well known in the art and will not be discussed in detail herein.

A main pane 1302 in the primary window 1300 of the interface shows information corresponding to the major information access categories, and any sub-categories of those categories such as the customer information, customer transactions, and receivable entry sub-categories shown under the branch transactions category. Each category may include one or more sub-categories, and each sub-category may itself contain sub-category layers. An example of sub-category layers includes the account, notes, photo/signature, and history sub-category layers of the customer information sub-category of the branch transactions category. The main pane in the primary window 1300 here shows information stored for a customer under the account sub-category layer. A “Personal” tab for this layer is shown to display information such as the name, address, and contact information for the customer, as well as a small image of the customer, customer identification numbers, recent activity information, account information, and account status. Other tabs for this layer include employment/risk, joint account, marketing, references, and other services tabs, which each can display pertinent information for that customer. A new transaction detail window 1304 can be displayed upon selecting a transaction detail option from the primary window, which allows the primary window to remain open. As shown, the transaction detail window 1304 includes information such as the type, amount, and date of each past check service transaction, as well as amounts due for those services. Each option of the primary window can open a new window as known in the art, in order to allow the main window to remain open. From the transaction detail window, the user can select a specific check or transaction, which generates yet another window 1306 showing an image of the check cashed, along with the digital signature captured for that customer and any other information such as the name, address, and photo of the customer. The user can scroll through the available checks using the scroll arrows, or can close the new window and select another check or transaction from the transaction detail window. Such an interface can allow a user to quickly and easily access and/or update customer information in an organized and sensible manner. This interface can be based upon any appropriate GUI technology, such as Web pages in a browser or panels generated by a standalone software program. Examples might include HTML pages, JSP pages, etc. Methods and devices for creating such interfaces are well known in the art and will not be discussed in detail herein.

Branches, Devices, and Workstations

A different hardware and device configuration can be used for each delivery channel as appropriate. Computer, IVR, CSR, and other systems can be used for call center channels, while Web servers and other devices can be used as known in the art to provide a customer with access to the various functions of the system through a Web channel. Within each channel, there also can be a number of different configurations based on factors such as location type and whether an employee is present at that location.

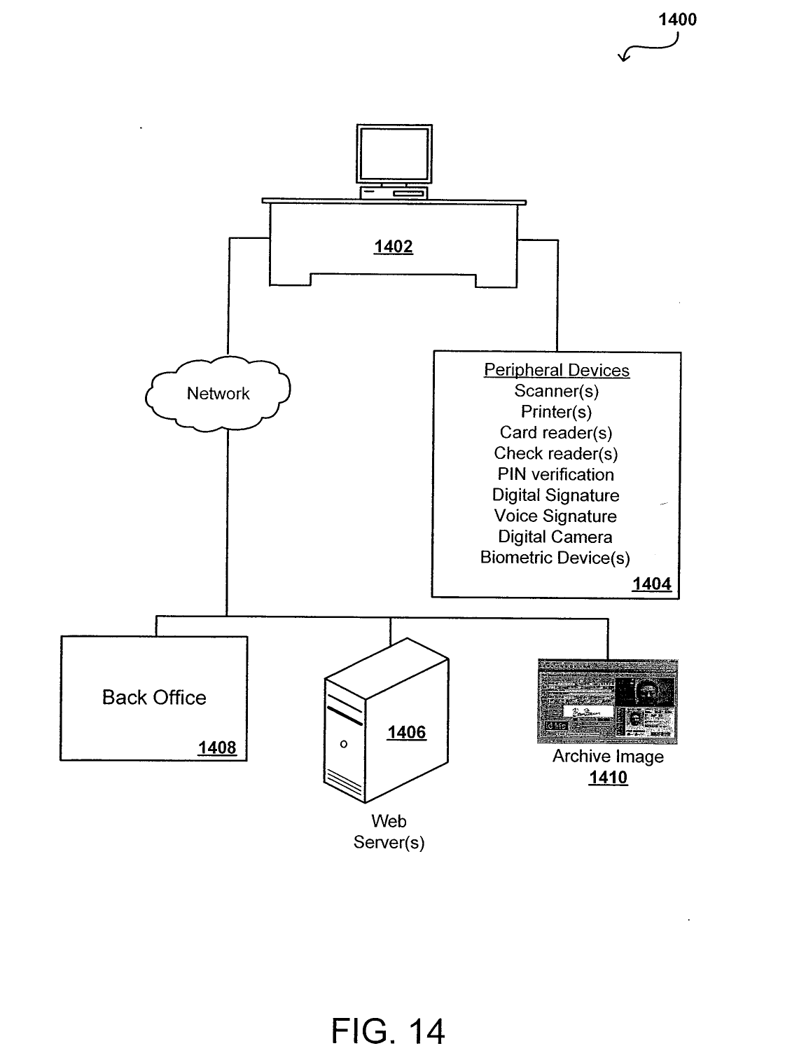

For example, a store location might include a number of workstations networked together, allowing a number of employees to concurrently handle a number of customers in the store. An exemplary system 1400 for serving such a need is shown in the diagram of FIG. 14. In this embodiment each employee operates a workstation 1402, which includes a desk with chairs for the employee and the customer(s), as well as a computer attached to the system by an appropriate network connection as known in the art. The computer can be connected to a variety of peripheral devices 1404 capable of serving the various financial services offered by the location. As seen in the figure, these devices can include scanners and printers for scanning and printing various documents, as well as card readers or check readers for reading information from items such as drivers licenses and personal checks. The workstation also can include a keypad for data entry and selection operations such as entering or selecting a personal PIN number, for the customer and/or for an ATM/debit card. The workstation also can include a digital signature capture device allowing for a digital version of the customer's signature to be captured. Since the customer typically will be present at the location and can provide a traditional signature, the digital signature capture device may not be necessary. The workstation also can include a biometric device for verifying the identity of a customer as described above.

The employee uses the workstation to access the system servers, such as a Web server 1406 capable of interfacing with the back-end systems and providing the employee with the necessary system functionality. The workstation also can allow the employee to communicate with the back office 1408, either directly or indirectly, to handle special situations, get transaction approval, or any of the other functions discussed herein that can be accomplished through the back office. Upon entering identity information for the in-store customer, the employee is displayed an image or pane of information 1410 on a computer screen or other display that allows the employee to verify the identity of the customer and continue processing the transaction. As seen, the image can contain information such as an existing image of the customer and a digital capture of the customer's signature, which can be used by the employee to verify the identity of the customer. Once the customer has been authenticated, the process continues as described above for other embodiments.

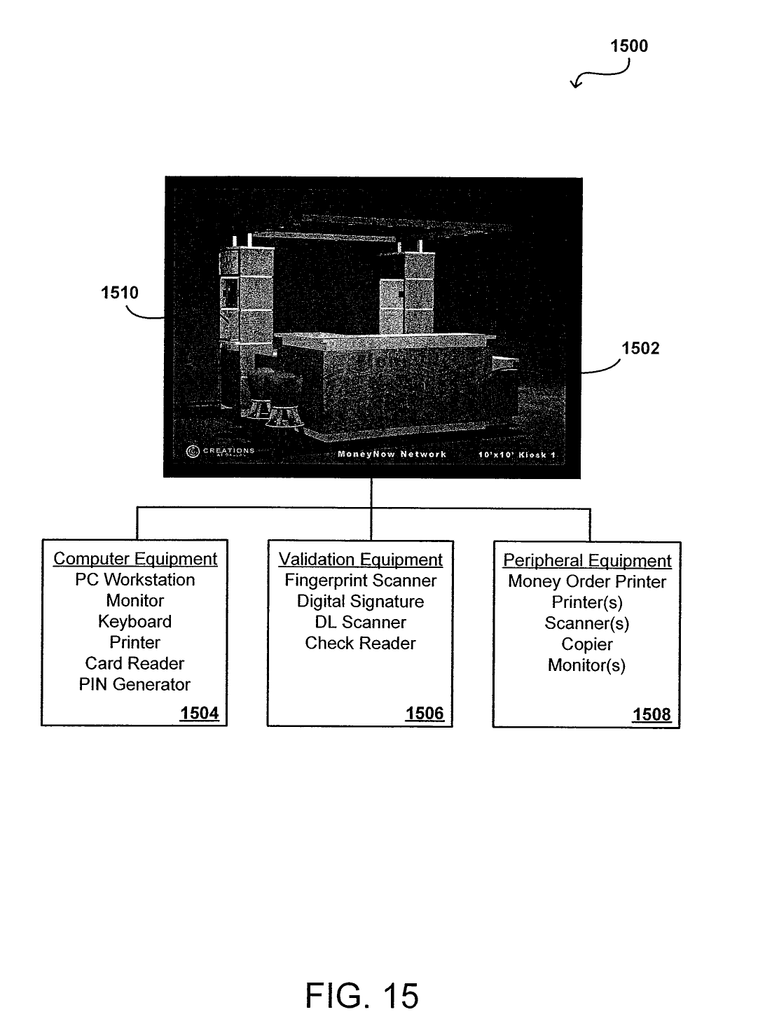

In contrast, the components of an exemplary mall branch location 1500 are shown in FIG. 15. As seen in the figure, an exemplary mall branch location includes an island-style workspace 1502, designed to be utilized in an open space or throughway in a mall or shopping center, for example. The workspace 1502 can support one or more employees, having one or more computer terminals or workstations allowing the employee(s) to access the system. The workspace also can include at least one kiosk-style terminal 1510 allowing customers to access the system without an employee, such as when the employee is busy or after standard business hours of the workspace. The inclusion of a kiosk-style terminal 1510 can provide a customer with 24 hour access to the system. Accordingly, such a location can include equipment that is appropriate for both a manned and an unmanned location. The workspace includes computer equipment 1504 as described elsewhere herein, which can include devices such as a PC workstation, monitor, keyboard, printer, card activation reader, and a pin number generator. The workspace also can include a variety of validation equipment 1506 as discussed elsewhere herein, such as biometric devices, fingerprint devices, digital signature capture devices, drivers license scanners, and check readers. The workspace also can include a variety of other peripheral equipment 1508 as described elsewhere herein, such as a money order printer, standard printer, and customer monitor. The equipment can be configured to provide for various applications and types of access described herein, including access to initial application, authentication, validation, request, and authorization applications.

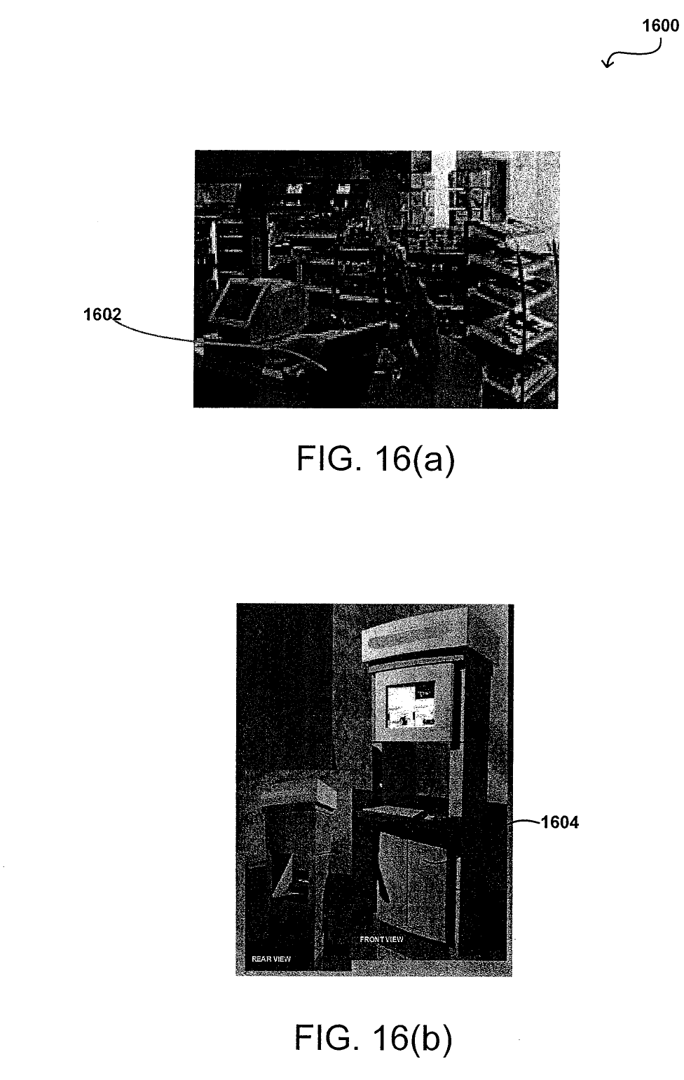

Another type of location is a satellite location 1600 as shown in FIG. 16, which can include many of the devices and equipment included with a mall location, depending upon whether the satellite location is a manned location 1602, such as at a counter of a convenience store, or a standalone kiosk-style location 1604, where no trained employee typically will be present. For a manned station, the equipment can include any equipment normally used at a workstation for a trained employee as described elsewhere herein. For the kiosk-style location, the kiosk can include basic components that allow the user to simply apply for a transaction, such as the user would do over a home computer connection. In an alternative embodiment, the kiosk can include biometric and other equipment that allows the customer to authenticate and/or validate the customer's identity, as well as to access various other features of the system as described elsewhere herein.

Although described with respect to financial services, it should be understood to one of ordinary skill in the art that advantages of a multi-channel delivery system, as well as identification, verification, and other processes as described that can be provided by such a system, can be obtained with other applications and implementations for any of a number of other purposes. The embodiments described herein are meant to be exemplary and are given for purposes of explanation and discussion, but are not meant to be exclusive or limiting as to applications, implementations, or variations of the various embodiments in accordance with the present invention.

Functionality of various embodiments can be implemented through any appropriate combination of hardware and software as known in the art. For example, software and control logic can be created by one of ordinary skill in the art using any suitable programming language, such as C or C++. Control logic can be stored in an information storage medium, contained internally or externally to the accessory and/or device, as a plurality of instructions or program code for directing an information or data processing device to perform steps, or sets of steps, which can indicate and/or be a result of the operational state of the accessory and/or device. Storage media and computer readable media for containing the code, or portions of the code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system for providing financial services, comprising:
a central decisioning system configured to accept application data for a customer requesting a financial service and determine whether to approve the request;
a Web access channel providing a first point of access to the central decisioning system;
a telephony channel providing a second point of access to the central decisioning system;
a branch location channel providing a third point of access to the central decisioning system; and
a funds management system operable to provide the requested financial service for an approved customer within about five minutes of an approval.

2. A system according to claim 1, wherein:
the selected financial service is selected from the group consisting of cash advances, cashless check cashing, money transfers, credit card applications, bill pay, product/service purchase, mortgage loans, discount programs, identity of theft services, internet access, shopping, financial service referrals, financial service discounts, check deposits, electronic check books, and online credit management.

3. A system according to claim 1, wherein:
the funds management system is further operable to provide the financial service by funding a debit card assigned to the customer by an approved amount of the requested financial service.

4. A system according to claim 1, wherein:
each of the Web access, telephony, and branch locations are operable to receive initial customer information for the customer and transmit that initial customer information to the central decisioning system for receiving a preliminary approval decision regarding the requested financial service.

5. A system according to claim 4, wherein:
the branch location is further operable to receive customer authentication information to be transmitted to the central decisioning system with the initial customer information for receiving a final approval decision regarding the requested financial service.

6. A system according to claim 5, wherein:
the customer authentication information includes information selected from the group consisting of biometric information, image information, digital signatures, audio signatures, usernames, user numbers, and PIN numbers.

7. A system according to claim 1, wherein:
the central decisioning system is further operable to receive customer data from third party data sourcing tools.

8. A system according to claim 1, wherein:
the central decisioning system further includes an automated decisioning engine capable of using the application data with a predictive decisioning model to determine whether to approve the request.

9. A system according to claim 1, wherein:
the customer has no preexisting relationship with the system.

10. A system according to claim 1, wherein:
the customer provides no immediate transfer of funds to the system.

11. A method for providing financial services, comprising:
receiving application data for a requested financial service for a customer through any of a Web access channel, telephony channel, and branch channel;
making a preliminary approval determination for the customer using a central decisioning system and providing the preliminary approval determination to the customer;
receiving authentication data for the customer, having received a favorable preliminary approval determination, through a branch channel;
making a final approval determination for the customer using the central decisioning system and providing the final approval determination to the customer; and
providing the requested financial service for the customer receiving a favorable final approval determination within about five minutes of the second approval determination.

12. A method according to claim 11, further comprising:
requiring the customer to approve at least one agreement before providing the requested financial service.

13. A method according to claim 11, wherein:
the selected financial service is selected from the group consisting of cash advances, cashless check cashing, money transfers, credit card applications, bill pay, product/service purchase, mortgage loans, discount programs, identity of theft services, internet access, shopping, financial service referrals, financial service discounts, check deposits, electronic check books, and online credit management.

14. A method according to claim 11, wherein:
providing the requested financial service includes funding a debit card assigned to the customer by an approved amount of the requested financial service.

15. A method according to claim 11, wherein:
receiving authentication data includes receiving information selected from the group consisting of biometric information, image information, digital signatures, audio signatures, usernames, user numbers, and PIN numbers.

16. A method according to claim 11, wherein:
making at least one of the preliminary and final approval decisions includes receiving customer data from third party data sourcing tools.

17. A system according to claim 1, wherein:
making at least one of the preliminary and final approval decisions includes using an automated decisioning engine capable of using the application data with a predictive decisioning model.

18. A method for providing financial services, comprising:
receiving a request for a financial service from an existing customer to a central decisioning engine through any of a Web access channel, telephony channel, and branch channel;
using existing customer information with a predictive decisioning model to automatically determine whether to provide the requested financial service;
providing an approval determination to the customer; and
providing the requested financial service for the customer receiving a favorable approval determination, within about five minutes of the approval determination.

19. A method according to claim 18, wherein:
providing the requested financial service includes funding a debit card assigned to the customer by an approved amount of the requested financial service.

20. A method according to claim 18, wherein:.
the selected financial service is selected from the group consisting of cash advances, cashless check cashing, money transfers, credit card applications, bill pay, product/service purchase, mortgage loans, discount programs, identity of theft services, internet access, shopping, financial service referrals, financial service discounts, check deposits, electronic check books, and online credit management.

21. A system for providing financial services with 24 hour availability, comprising:
a satellite workstation including a display device and an input device, the satellite workstation allowing a customer to input application data for a requested financial service;
a central decisioning system in communication with the satellite workstation, the central decisioning system operable to use the application data and existing customer data with a predictive decisioning model to automatically determine whether to provide the requested financial service; and
a funds management system operable to provide the requested financial service for the customer within about five minutes of approval of the requested financial service.

22. A system according to claim 21, wherein:
the selected financial service is selected from the group consisting of cash advances, cashless check cashing, money transfers, credit card applications, bill pay, product/service purchase, mortgage loans, discount programs, identity of theft services, internet access, shopping, financial service referrals, financial service discounts, check deposits, electronic check books, and online credit management.

23. A system according to claim 21, wherein:
the funds management system is further operable to provide the requested financial service by funding a debit card assigned to the customer by an approved amount of the requested financial service.

24. A system according to claim 21, wherein:
the satellite workstation is further operable to receive customer authentication information to be transmitted to the central decisioning system with the application data.

25. A system according to claim 24, wherein:
the customer authentication information includes information selected from the group consisting of biometric information, image information, digital signatures, audio signatures, usernames, user numbers, and PIN numbers.
